(19) United States
(12) Patent Application Publication
(10) Pub. No.: US 2024/0296546 A1
(43) Pub. Date: Sep. 5, 2024

(54) SYSTEMS AND METHODS FOR QUALITY CONTROL OF MICROARRAY PRINTING

(71) Applicant: SAFEGUARD BIOSYSTEMS HOLDINGS LTD., London (GB)

(72) Inventor: Amir Mohammad MAZOUCHI, Toronto (CA)

(73) Assignee: SAFEGUARD BIOSYSTEMS HOLDINGS LTD., London (GB)

(21) Appl. No.: 18/258,237

(22) PCT Filed: Dec. 22, 2021
(86) PCT No.: PCT/EP2021/087440

§ 371 Date: Jun. 19, 2023

Related U.S. Application Data
(60) Provisional application No. 63/130,485, filed on Dec. 24, 2020.

(51) Int. Cl. G06T 7/00; G06T 5/30; G06T 7/194; G06T 7/62; G06T 7/64; G06T 7/68; G06T 7/70

(52) U.S. Cl. CPC G06T 7/001; G06T 5/30; G06T 7/194; G06T 7/62; G06T 7/64; G06T 7/68; G06T 7/70; G06T 2200/04; G06T 2207/10056; G06T 2207/20036; G06T 2207/30144

(57) ABSTRACT

Methods are provided for the analysis of microarray images. The methods described automate the image-based quality control of a microarray and the subsequent quantitative assessment of the analysis that the microarray image represents. The methods comprise generating a reference array using raw image data based on which the microarray can then be located. Once the array is located, the quality of the individual print spots can be analyzed.

### 1. CROSS REFERENCE TO RELATED APPLICATIONS

This application claims the priority benefit of U.S. provisional application No. 63/130,485, filed Dec. 24, 2020, the contents of which are incorporated herein in their entireties by reference thereto.

### 2. BACKGROUND

Microarrays are widely used for applications such as molecular profiling, identification of new drug targets, discovery of biomarkers or genome annotation. Microarrays are fabricated using automated instruments to deposit or spot minute amounts of chemical or biological substances, such as DNA, RNA, cDNA, polynucleotides, oligonucleotides, and proteins in a dense array of minute fluid droplets on a substrate, such as a glass slide.

The ability to produce spotted microarrays in large quantity, rapidly, at reasonable cost, and with uniform and consistent deposition properties, such as spot size, shape and density, has significant industrial and economic importance. Historically, quality control for the fabrication of microarray assay reaction plates relied on manual visual checks, which is time-consuming, error prone, and tedious for humans to perform. It also limits production capacity and often delays the delivery of reaction plate array products to customers.

While some attempts have been made to automate detection of spot finding errors and spots of poor quality, current implementations require the user to specify the physical parameters of the microarray, such as spot diameter and pitch, and explicit thresholds or ranges of various attributes, such as brightness, which separate acceptable from unacceptable spots. Choosing thresholds or ranges manually for multiple attributes is time-consuming and may not achieve the desired result. In addition, arrays can use non-standard array parameters that typically have to be determined by the investigator, and the location of the array itself within a well-type substrate may require manual intervention.

The major sources of uncertainty in spot finding on microarrays are variable spot size and position, variation of the image background, and discrete image artifacts. Spots vary significantly in size, shape, and position within their vignettes despite the use of precise robotic tools to lay them out. The raw microarray image will also typically contain both static background, which is modulated by the illumination profile and affects the spot array, as well as local, non-static background, high frequency background such as dust, which further complicates signal analysis. In many cases, spot finding errors can lead to an entire microarray being labeled defective, when in fact the spot finding methodology merely failed to locate one or two spots that were present but simply mislocalized or misshapen.

The present disclosure addresses the unmet need of overcoming position and size variations while dealing robustly with image noise and artifacts in solving the spot finding problem in microarray analysis without requiring the derivation of multiple investigator-determined parameters.

### 3. SUMMARY

The present disclosure provides methods and system for detecting labeled molecules printed at discrete locations on a solid surface. The labeled molecules are printed or deposited on the array in the form of regions referred to as “spots,” typically in a grid pattern. The printed grid pattern is sometimes referred to as the “grid”. The methods of the disclosure rely on data from the printed array itself to generate a reference array and thus locate the grid. Once the grid is located on the array, a positional address “map” of the labeled molecules on the array can be generated, allowing the spots to be used in a molecular assay, e.g., an assay of a biological sample to determine if the sample contains a molecule that binds to a molecule on the array, e.g., in a DNA hybridization assay.

Traditionally, quality control methods for spot printing have entailed overlaying the spot images with the image of a hypothetical reference array intended by the printing process, with deviations from the shape, size and location intended by the printing processes potentially resulting in the quality control method rejecting the array. In contrast, because the methods of the present disclosure utilize image data from the actual array rather than from a hypothetical array to generate the positional address “map” of the array, the methods permit the use of microarrays that do not conform to the intended print pattern. Thus arrays that traditional methods might consider missing due to mislocalized, absent or misshapen spots will be found and counted. Accordingly, the methods described herein permit the utilization of arrays that other quality control methods might reject and further permit generating a map of the positionally addressable array by locating the “address” or “location” of spots for downstream use.

The methods of the disclosure generally comprise using image data from signals, e.g., fluorescent signal, of labeled probe molecules present in the array to generate a reference array, and using the reference array to locate the position of the grid and consequently the expected position of the spots. Once the spots have been localized, the quality of individual spots can be analyzed to determine if they are adequate for use in a downstream assay.

### 4. BRIEF DESCRIPTION OF THE FIGURES

FIGS. 1A-1E show a flow-chart summarizing an exemplary method of the disclosure that performs both (i) grid localization on an array as well as (ii) determination of the spot quality. The present methods encompass performing grid localization only (e.g., as illustrated in FIGS. 1A-1B), performing spot quality determination only (e.g., as illustrated in FIGS. 1C-1E, for example using a grid localized through other methods or a grid previously localized using the methods disclosed herein), and performing both grid localization and spot quality determination on an array.

FIG. 2 illustrates the determination of the array parameters in an exemplary method and system of the disclosure. Spot diameter and spot spacing are determined by autocorrelation of the array image. Spot diameter (spotD) is proportional to the size of the central spot, which is fitted to a Gaussian curve. Spot pitch is the mean distance between peaks in vertical and horizontal cross section from the center of autocorrelation.

FIGS. 3A-3C illustrate an embodiment for determining the grid position on the array. A reference array is constructed using the array parameters spotD and spot pitch (see FIG. 3A). A morphological presentation of the array image is created by standard morphological opening, comprising erosion and dilation (Imorph) (see FIG. 3B). Normalized correlation of the reference array with the Imorph is used to determine the location of the grid within the raw image. The expected position of each spot can then be calculated (see FIG. 3C).

FIG. 4 illustrates an embodiment for removal of the static background from a well image. Static (long scale or low frequency) background is removed from the well image through standard morphological opening, comprising erosion and dilation, to create a flat image.

FIGS. 5A-5C illustrate an embodiment for analysis of a spot for dust artefacts. A dust score >0 indicates the possibility of dust on the spot. However, printing artefacts can produce dust score of 1 and even 2. So a low dust score may suggest a manual inspection is warranted.

FIG. 6 illustrates an embodiment for analysis of a spot for asymmetry. The asymmetry score varies between 0 and 1. The larger the number, the higher is the difference between max and average values, the more asymmetric is the spot.

### 5. DETAILED DESCRIPTION

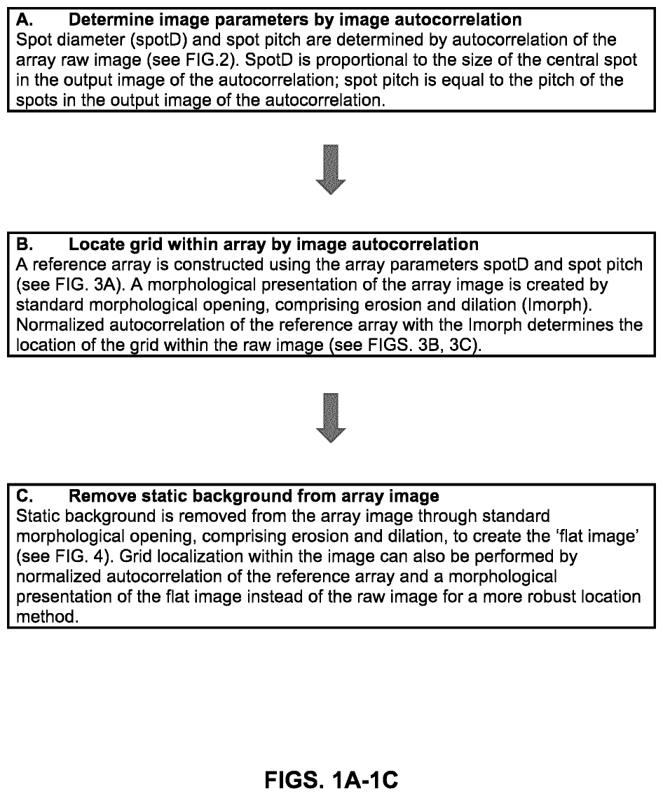

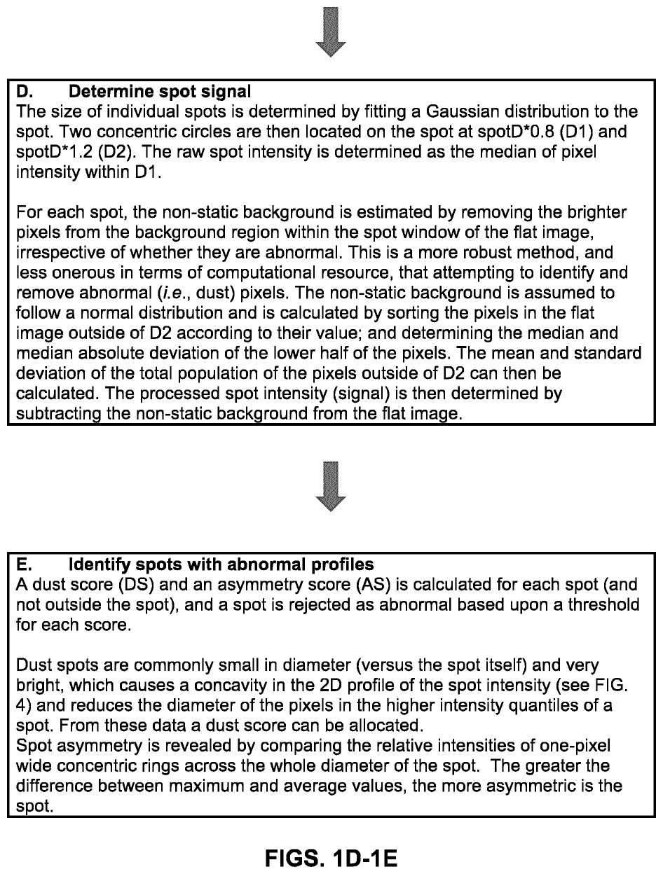

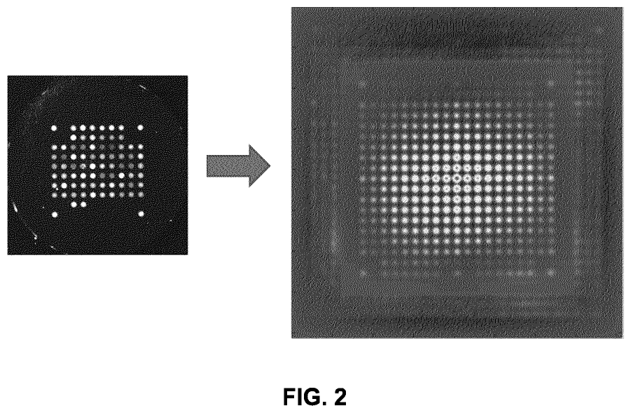

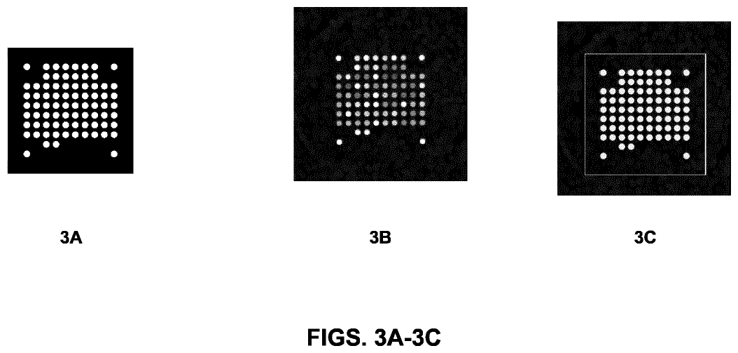

Methods are system and systems are provided herein provided for creating a positionally addressable map of a microarray (see, e.g., FIG. 1A) and/or characterizing the quality of spots on a positionally addressable microarray (see, e.g., FIG. 1B).

### 5.1. Definition

Unless defined otherwise herein, all technical and scientific terms used herein have the same meaning as commonly understood by one of ordinary skill in the art. Various scientific dictionaries that include the terms included herein are well known and available to those in the art.

As used herein, the singular forms “a”, “an” and “the” include plural referents unless the content and context clearly dictates otherwise. Thus, for example, reference to “a protein marker” includes a combination of two protein markers, a combination of three protein markers, and the like.

Unless indicated otherwise, an “or” conjunction is intended to be used in its correct sense as a Boolean logical operator, encompassing both the selection of features in the alternative (A or B, where the selection of A is mutually exclusive from B) and the selection of features in conjunction (A or B, where both A and B are selected). In some places in the text, the term “and/or” is used for the same purpose, which shall not be construed to imply that “or” is used with reference to mutually exclusive alternatives.

The terms “about”, “approximately” and the like are used throughout the specification in front of a number to show that the number is not necessarily exact (e.g., to account for fractions of the time periods recited, variations in measurement accuracy and/or precision, timing, etc.). It should be understood that a disclosure of “about X” or “approximately X” where X is a number is also a disclosure of “X.”

### 5.2. Methods for Creating a Positionally Addressable Map of a Microarray

The disclosure provides methods for characterizing identifying the positional address of spots on a microarray.

The methods generally comprise: (a) illuminating a microarray (the “array”) comprising fluorescently labeled probe molecules present in spots on the array (the “spot array” or “grid”) such that the fluorescent label in the probe molecules is excited; (b) detecting the fluorescent signals emitted by the fluorescently labeled molecules; (c) processing the detected signals into a raw image; (d) locating the spot array or grid on the raw image using a reference array; and (e) optionally, analyzing the quality of individual spots in the microarray, thereby identifying the positional address of spots on a microarray. The method comprises optionally further analyzing the quality of individual spots in the microarray, e.g., to characterize the quality of a positionally addressable microarray. Preferably, the reference array is generated using raw image data.

In some aspects, the methods comprise (a) detecting raw image parameters; and (b) locating the spot array based on the raw image parameters.

Locating the spot array can comprise performing a regular autocorrelation function on the raw image to produce an autocorrelation image. However, a better option for the autocorrelation function is the normalized version, which can be implemented using a standard software package, e.g., the norm×corr2 function of MATLAB:

### Algorithms

norm×corr2 uses the following general procedure [1], [2]:
1. Calculate cross-correlation in the spatial or the frequency domain, depending on size of images.
2. Calculate local sums by precomputing running sums [1].
3. Use local sums to normalize the cross-correlation to get correlation coefficients.

The implementation closely follows the formula from [1]:

$$γ ( u , v ) = \frac{{\sum }_{x , v} [ f ( x , y ) - {\overline{f}}_{u , v} ] [ t ( x - u , y - v ) - \overline{t} ]}{{\{ {{\sum }_{x , y} [ f ( x , y ) - {\overline{f}}_{u , v} ]}^{2} {{\sum }_{x , y} [ t ( x - u , y - v ) - \overline{t} ]}^{2} \}}^{0.5}}$$

where
f is the image.
t̅ is the mean of the template
f̅_{u,v} is the mean of f(x, y) in the region under the template.

In particular embodiments, detecting the spot array further comprises, using autocorrelation data: (a) calculating the diameter (“D”) of the central spot on the autocorrelation image; (b) calculating the pitch between adjacent peaks (e.g., the central peak and adjacent peaks) on the autocorrelation image; (c) constructing a reference array using the diameter and pitch values; (d) calculating a morphological presentation of the raw image (Imorph); and (e) correlating the reference array with the Imorph to locate the spot array on the raw image. As used herein, the term “central spot” refers to the spot in the center of autocorrelation image and its peak referred to as the “central peak” which also the brightest peak in the autocorrelation image.

Spot diameter (spotD), which is proportional to the size of the central spot, is estimated to be 1/√2×D. SpotD can be calculated using a Gaussian fitting algorithm. Spot pitch can be determined by calculating mean distance between adjacent peaks in the autocorrelation image, e.g., adjacent peaks in vertical and horizontal cross sections from the center of the autocorrelation.

Generating a morphological presentation of the raw image (Imorph) can comprise applying morphological opening operations (“A”) to the raw image, for example using an erosion filter and a dilation filter, wherein the shape of the structuring elements closely approximates that of the individual spots. In particular embodiments, for disk-shaped spots, the erosion filter and dilation filter can use a disk-shaped structuring element. A suitable diameter for the structuring element for morphological opening operations “A” is ≤0.9D and in some embodiments ranges between 0.7D and 0.9D, e.g., is 0.7D or 0.8D.

Another set of morphological opening operations (“B”) can be used to remove static background from the raw image or Imorph to generate a flat image. Morphological opening operations “B” can also comprise an erosion filter and a dilation filter, wherein the shape of the structuring elements closely approximates that of the individual spots. In particular embodiments, for disk-shaped spots, the erosion filter and dilation filter can use a disk-shaped structuring element. A suitable diameter for the structuring element for morphological opening operations “B” is ≥1.1D and in some embodiments ranges between 1.1D and 1.3D, e.g., is 1.2D or 1.3D.

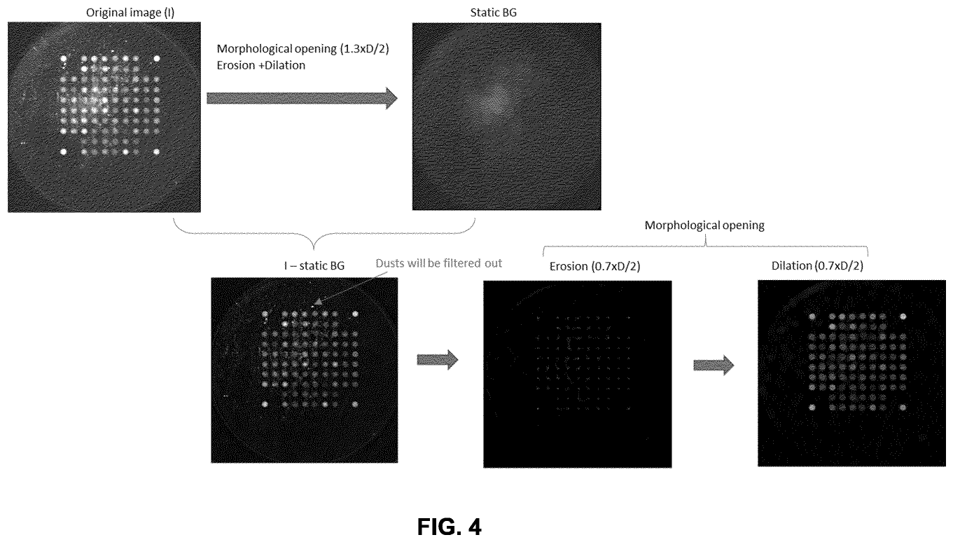

An exemplary method of applying morphological opening operations is illustrated in FIG. 4.

### 5.3. Methods for Analyzing Spot Quality

The present disclosure further provides methods of analyzing the quality of individual spots in a microarray, e.g., to characterize the quality of a positionally addressable microarray, for example in conjunction with an array map generated according to the methods disclosed herein.

In certain aspects, the methods comprise determining the non-static (short scale or high frequency) background of individual spots on an array using a statistical approach. Non-static background refers to sharp variations of pixel intensity in an intensity profile that is otherwise mostly smooth (e.g., constant or varying gradually). In some embodiments, the statistical approach assumes that the pixel intensities in the absence of an outlier would be characterized by a normal distribution and pixels in the lower half of the normal distribution are not affected by outliers such as would be caused by dust. Using these assumptions, the non-static background can be estimated by (a) sorting pixels in the background region of an individual spot window according to their value; (b) calculating the median intensity of the pixels in the lower half (MED_{L}); (c) calculating the median absolute deviation (MAD_{L}) of the pixels in the lower half; and (d) determining the non-static background based on MED_{L} and MAD_{L}. The non-static background can be determining by estimating its average and standard deviation from the determined MED_{L} and MAD_{L}, which ensures the calculated average and standard deviation will be minimally affected by outlier pixels. In step (a), the pixels can be sorted in a flat image (e.g., the raw image from which the static background has been subtracted) of the spot, preferably in the individual spot window within the background region. The term “spot window” refers to a box centered at the expected position of the spot with sides equal to spot pitch, and the term “background region” refers to the area within the spot window but outside a certain multiplier of the spot diameter (e.g., ≥1.1D, e.g., 1.2D or 1.3D).

Determining the non-static background can be achieved by applying the formula mean (background)=MED_{L}+1.4×MAD_{L}

Analyzing the quality of an individual spot can comprise: (a) identifying spots with dust present; and/or (b) determining the degree of asymmetry of the individual spot.

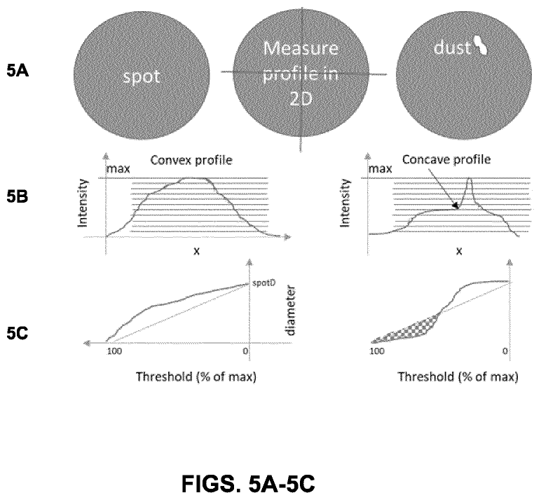

Identifying a spot with dust present can be achieved by analyzing the concavity of an intensity profile of the individual spots, for example by a method comprising: (a) mapping the diameter of a spot intensity region with intensities ranging from 0 to the maximum pixel intensity, to generate a spot intensity profile; and (b) determining if the spot intensity profile has a concave region (i.e., at least a portion of the profile is characterized by concavity), which is indicative of a dust particle. The term “spot intensity region” refers to a collection of pixels, typically comprising connected pixels but which can also include pixels that are discontinuous, with intensities of boundary pixels above a threshold (these can also be referred to as “intensity contours”). In some embodiments, the intensities can also be below a second threshold. Discontinuity can occur as a result of an artefact, e.g., debris on the solid surface. This method of identifying a spot with dust present is illustrated in FIGS. 5A-5C.

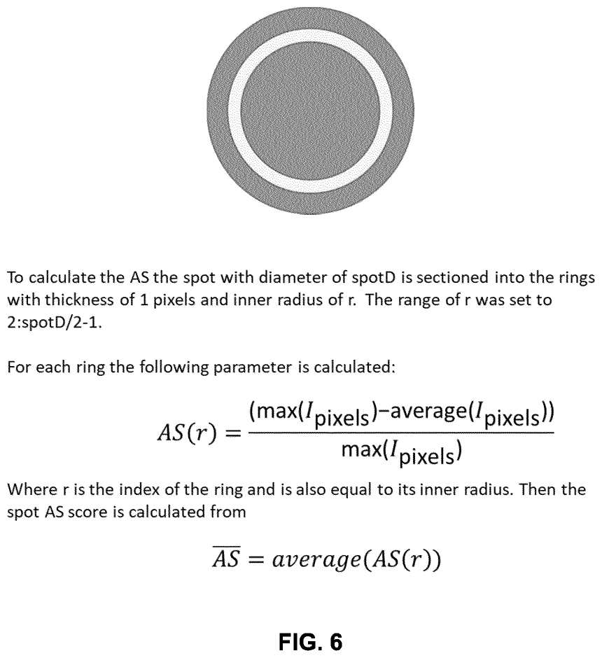

Determining the degree of asymmetry of the individual spot can be achieved by: (a) sectioning the spot (e.g., using the raw image or the flat image generated as described herein) into a plurality of rings; (b) determining the maximum and average pixel intensity values in each ring; and (c) calculating an asymmetry score for each ring based on the difference between maximum and average pixel intensity values in the ring. This method of identifying a spot with dust present is illustrated in FIG. 6.

If an array is deemed to have sufficient spots of suitable quality, it can be utilized in an analytical assay, for example in a hybridization assay to detect a biological molecule (e.g., DNA or RNA) in a sample (e.g., in a biological sample).

If an array is deemed to have insufficient spots of suitable quality for an analytical assay, it can be discarded.

### 5.4. Exemplary Arrays

The present systems and methods can be used to locate and control the quality of any type of microarray containing a labeled molecule, for example a labeled nucleic acid or a peptide or protein.

In the present specification, the term “nucleic acid” means a nucleotide polymer of any length, including oligonucleotides and longer polynucleotides. The term “nucleic acid” includes naturally occurring and synthetic DNA and RNA as well as artificial nucleic acids such as peptide nucleic acids, morpholino nucleic acids, methylphosphonate nucleic acids and S-oligonucleic acids. As used herein, “polypeptide”, “peptide” and “protein” are used interchangeably and include reference to a polymer of amino acid residues. The terms apply to amino acid polymers in which one or more amino acid residue is an artificial chemical analogue of a corresponding naturally occurring amino acid, as well as to naturally occurring amino acid polymers. The term “residue” or “amino acid residue” or “amino acid” includes reference to an amino acid that is incorporated into a protein, polypeptide, or peptide (collectively “peptide”). The amino acid can be a naturally occurring amino acid and, unless otherwise limited, can encompass known analogs of natural amino acids that can function in a similar manner as naturally occurring amino acids.

Preferably, the nucleic acid is an oligonucleotide, e.g., an oligonucleotide of 12-50 nucleotides, whether naturally occurring or modified.

The microarrays typically comprise at least 12 spots, at least 24 spots, at least 48 spots, or at least 72 spots.

The spots can be three-dimensional. Three dimensional spots can contain a polymer containing the labeled molecules. A suitable microarray system takes advantage of three-dimensional crosslinked polymer networks, for example as described in U.S. Pat. No. 9,738,926, the contents of which are incorporated by reference herein in their entireties.

The methods of the disclosure can entail printing a plurality of labeled probe molecules in three-dimensional spots at discrete locations on a solid surface to form the microarray, for example by operating a movable printer head to deposit the plurality of fluorescently labeled probe molecules in spots at discrete locations on the solid surface.

The labeled molecules typically include a label that can be detected by the available optical instrumentation. In preferred embodiments, the label is fluorescent label, for example a xanthene dye, which is optionally a fluorescein or rhodamine dye such as fluorescein isothiocyanate (FITC), a cyanine dye, which is optionally a Cy3, Cy5 or Cy7 dye, and/or a coumarin, which is optionally umbelliferone. Preferred dyes are Cy3 and/or Cy5.

The arrays can include the spots printed in a grid pattern, for example at a spot density of at least at least 20 spots/cm², at least 50 spots/cm², or at least 100 spots/cm². The grid pattern need not have a spot at every node of the grid and may include spots printed in any variety of patterns.

The array can be printed on any suitable surface, for example in a well of a 96-well plate, a slide, a biochip or a cartridge.

### 5.5. Computer Implementation

Many, or substantially all, aspects of the methods of the disclosure can be implemented by a computer.

Accordingly, the disclosure provides computer-implemented methods for identifying the positional address of spots on a microarray (for example as described in Section 5.5.1) and/or for analyzing the quality of individual spots in the microarray, e.g., to characterize the quality of a positionally addressable microarray (for example described in Section 5.5.2).

The computer-implemented methods can be applied to any spot size and particularly suited to spots that are imaged at a magnification/resolution that corresponds to a spot diameter of at least 18 pixels, at least 20 pixels, and more preferably at least 22 pixels on the raw image.

The computer-implemented methods of described herein (whether the steps of generating an array map and/or assessing print quality) can be performed without using predetermined and/or user determined parameters, such predetermined spot diameter and/or spot pitch based on the expected print pattern on the microarray. Rather, in some embodiments, the methods entail relying on the image data itself to generate reference array and/or localize the grid and/or determine spot quality.

The computer-implemented methods can include providing notifications to the user, for example concerning the positional address of spots on a microarray and/or the quality of the microarray (with the latter optionally including a pass/fail assessment, whether concerning a single spot or the entire array).

### 5.5.1. Computer Based Methods for Generating an Array Map

The methods typically comprise, in a computer system having one or more processors coupled to a memory storing one or more computer readable instructions for execution by the one or more processors, the one or more computer readable instructions comprising instructions for: (a) receiving raw images obtained by: (i) illuminating a microarray (the “array”) comprising labeled probe molecules present in spots on the array (the “spot array” or “grid”) such that the label in the probe molecules is excited; and (ii) detecting the signals emitted by the labeled molecules; (b) processing the detected signals into a raw image; (c) locating the spot array or grid on the raw image using a reference array which can be generated using raw image data; and (d) optionally analyzing the quality of individual spots in the microarray. Preferably, the labeled probe molecules are fluorescently labeled probe molecules.

In some aspects, locating the spot array or grid comprises: (a) detecting raw image parameters; and (b) locating the spot array based on the raw image parameters.

Locating the spot array can comprise performing a regular autocorrelation function on the raw image to produce an autocorrelation image. However, a better option for the autocorrelation function is the normalized version, which can be implemented using a standard software package, e.g., the norm×corr2 function of MATLAB:

### Algorithms

norm×corr2 uses the following general procedure [1], [2]:
1. Calculate cross-correlation in the spatial or the frequency domain, depending on size of images.
2. Calculate local sums by precomputing running sums [1].
3. Use local sums to normalize the cross-correlation to get correlation coefficients.

The implementation closely follows the formula from [1]:

$$γ ( u , v ) = \frac{{\sum }_{x , v} [ f ( x , y ) - {\overline{f}}_{u , v} ] [ t ( x - u , y - v ) - \overline{t} ]}{{\{ {{\sum }_{x , y} [ f ( x , y ) - {\overline{f}}_{u , v} ]}^{2} {{\sum }_{x , y} [ t ( x - u , y - v ) - \overline{t} ]}^{2} \}}^{0.5}}$$

where
f is the image.
t̅ is the mean of the template
f̅_{u,v} is the mean of f(x, y) in the region under the template.

In particular embodiments, detecting the spot array further comprises, using autocorrelation data: (a) calculating the diameter (“D”) of the central spot on the autocorrelation image; (b) calculating the pitch between adjacent peaks (e.g., the central peak and adjacent peaks) on the autocorrelation image; (c) constructing a reference array using the diameter and pitch values; (d) calculating a morphological presentation of the raw image (Imorph); and (e) correlating the reference array with the Imorph to locate the spot array on the raw image. As used herein, the term “central spot” refers to the spot in the center of autocorrelation image and its peak referred to as the “central peak” which also the brightest peak in the autocorrelation image.

Spot diameter (spotD), which is proportional to the size of the central spot, is estimated to be 1/√2×D. SpotD can be calculated using a Gaussian fitting algorithm. Spot pitch can be determined by calculating mean distance between adjacent peaks in the autocorrelation image, e.g., adjacent peaks in vertical and horizontal cross sections from the center of the autocorrelation.

Generating a morphological presentation of the raw image (Imorph) can comprise applying morphological opening operations (“A”) to the raw image, for example using an erosion filter and a dilation filter, wherein the shape of the structuring elements closely approximates that of the individual spots. In particular embodiments, for disk-shaped spots, the erosion filter and dilation filter can use a disk-shaped structuring element. A suitable diameter for the structuring element for morphological opening operations “A” is ≤0.9D and in some embodiments ranges between 0.7D and 0.9D, e.g., is 0.7D or 0.8D.

Another set of morphological opening operations (“B”) can be used to remove static background from the raw image or Imorph to generate a flat image. Morphological opening operations “B” can also comprise an erosion filter and a dilation filter, wherein the shape of the structuring elements closely approximates that of the individual spots. In particular embodiments, for disk-shaped spots, the erosion filter and dilation filter can use a disk-shaped structuring element. A suitable diameter for the structuring element for morphological opening operations “B” is ≥1.1D and in some embodiments ranges between 1.1D and 1.3D, e.g., is 1.2D or 1.3D.

### 5.5.2. Computer-Implemented Methods for Assessing Array Quality

The present disclosure further provides computer-implemented methods of analyzing the quality of individual spots in a microarray, e.g., to characterize the quality of a positionally addressable microarray, for example in conjunction with an array map generated according to the methods disclosed herein.

In certain aspects, the methods comprise determining the non-static background of individual spots on an array using a statistical approach. In some embodiments, the statistical approach assumes that the pixel intensities in the absence of an outlier would be characterized by a normal distribution. The approach further assumes that pixels with lower intensity do not represent dust particles while higher intensity pixels may have been affected by the presence of outliers such as would be caused by dust. Using these assumptions, the non-static background can be estimated by (a) sorting pixels in the background region of an individual spot window according to their value; (b) calculating the median intensity of the pixels in the lower half (MED_{L}); (c) calculating the median absolute deviation (MAD_{L}) of the pixels in the lower half; and (d) determining the non-static background based on MED_{L} and MAD_{L}. The non-static background can be determining by estimating its average and standard deviation from the determined MED_{L} and MAD_{L}, which ensures the calculated average and standard deviation will be minimally affected by outlier pixels. In step (a), the pixels can be sorted in a flat image (e.g., the raw image from which the static background has been subtracted) of the spot, preferably in the individual spot window within the background region. The term “spot window” refers to a box centered at the expected position of the spot with sides equal to spot pitch, and the term “background region” refers to the area within the spot window but outside a certain multiplier of the spot diameter (e.g., ≥1.1D, e.g., 1.2D or 1.3D).

Determining the non-static background can be achieved by applying the formula mean (background)=MED_{L}+1.4×MAD_{L}

Analyzing the quality of an individual spot can comprise: (a) identifying spots with dust present; and/or (b) determining the degree of asymmetry of the individual spot.

Identifying a spot with dust present can be achieved by analyzing the concavity of an intensity profile of the individual spots, for example by a method comprising: (a) mapping the diameter of a spot intensity region, which refers to a collection of pixels, typically comprising connected pixels but which can also include pixels that are discontinuous, with intensities of boundary pixels above a threshold, with intensities ranging from 0 to the maximum pixel intensity, to generate a spot intensity profile; and (b) determining if the spot intensity profile has a concave region (i.e., at least a portion of the profile is characterized by concavity), which is indicative of a dust particle. This method of identifying a spot with dust present is illustrated in FIGS. 5A-5C.

Determining the degree of asymmetry of the individual spot can be achieved by: (a) sectioning the spot (e.g., using the raw image or the flat image generated as described herein) into a plurality of rings; (b) determining the maximum and average pixel intensity values in each ring; and (c) calculating an asymmetry score for each ring based on the difference between maximum and average pixel intensity values in the ring. This method of identifying a spot with dust present is illustrated in FIG. 6.

The computer-implemented methods can further comprise assigning each spot in an array, or the array itself, a pass/fail score.

The computer-implemented method can also comprise providing a notification to a user, e.g., concerning the quality of the microarray.

### 5.6. Systems

The present disclosure provides systems configured to perform one or more of the methods disclosed herein.

Thus, the present disclosure provide a system configured to identify the positional address of spots on a microarray and/or optionally analyze the quality of individual spots in the microarray, e.g., to characterize the quality of a positionally addressable microarray.

Accordingly, in some embodiments, the systems of the disclosure are configured to perform any of the computer-implemented methods disclosed in Section 5.5 and subsections thereof.

The systems of the disclosure can include one or more processors coupled to a memory storing one or more computer readable instructions for execution by the one or more processors.

The systems of the disclosure can include one or more of the following linked to the computer(s) implementing the methods of the disclosure and/or to one another: (a) a microscope, e.g., a microscope is attached to a platform capable of holding the microarray; (b) a camera, e.g., a camera capable of capturing the label on the labeled molecules on an array; (c) a light source, e.g., capable of exciting the labeled molecules (e.g., fluorescently labeled molecules) on an array and/or illuminating an array to permit its image to be captured and/or (d) an array printing device. The various components can be designed to be operated robotically.

### 6. SPECIFIC EMBODIMENTS

While various specific embodiments have been illustrated and described, it will be appreciated that various changes can be made without departing from the spirit and scope of the disclosure. The present disclosure is exemplified by the numbered embodiments set forth below.

1. A method for characterizing identifying the positional address of spots on a microarray, comprising:
(a) illuminating a microarray (the “array”) comprising labeled probe molecules present in spots on the array (the “spot array”) such that the label in the probe molecules is excited, optionally wherein the probe molecules are fluorescently labeled;
(b) detecting the signals emitted by the labeled molecules;
(c) processing the detected signals into a raw image;
(d) locating the spot array on the raw image using a reference array; and
(e) optionally, analyzing the quality of individual spots in the microarray,
thereby identifying the positional address of spots on a microarray and optionally analyzing the quality of individual spots in the microarray, e.g., to characterize the quality of a positionally addressable microarray.

2. The method of embodiment 1, wherein the probe molecules are fluorescently labeled and wherein the signals detected are fluorescent signals.

3. The method of embodiment 1 or embodiment 2, wherein the reference array is generated using raw image data.

4. The method of any one of embodiments 1 to 3, wherein locating the spot array comprises:
(a) detecting raw image parameters; and
(b) locating the spot array based on the raw image parameters.

5. The method of any one of embodiments 1 to 4, wherein locating the spot array comprises performing an autocorrelation function on the raw image to produce an autocorrelation image.

6. The method of embodiment 5, wherein performing the autocorrelation function comprises performing a normalized autocorrelation.

7. The method of embodiment 5 or embodiment 6, wherein detecting the spot array further comprises, using autocorrelation data:
(a) calculating the diameter (“D”) of the central spot on the autocorrelation image;
(b) calculating the pitch between adjacent peaks (e.g., the central peak and adjacent peaks) on the autocorrelation image;
(c) constructing a reference array using the diameter and pitch values;
(d) calculating a morphological presentation of the raw image (Imorph); and
(e) correlating the reference array with the Imorph to locate the spot array on the raw image.

8. The method of embodiment 7, wherein the diameter of the central spot on the autocorrelation image is calculated using a Gaussian fitting algorithm which is optionally a 2D Gaussian fitting algorithm.

9. The method of embodiment 7 or embodiment 8, wherein the pitch is calculated as the mean distance between peaks in the autocorrelation image.

10. The method of embodiment 9, wherein the adjacent peaks comprise adjacent peaks along the horizontal central line.

11. The method of embodiment 9 or embodiment 10, wherein the adjacent peaks comprise adjacent peaks along the vertical central line.

12. The method of any one of embodiments 7 to 11, wherein generating a morphological presentation of the raw image (Imorph) comprises applying morphological opening operations “A”) to the raw image.

13. The method of embodiment 12, wherein morphological opening operations “A” comprise an erosion filter and a dilation filter.

14. The method of embodiment 13, wherein the erosion filter and dilation filter of morphological opening operation “A” utilize a disk-shaped structuring element with a diameter of ≤0.9D.

15. The method of any one of embodiments 1 to 14, which comprises applying morphological opening operations “B” to calculate and remove static background, thereby generating a flat image.

16. The method of embodiment 15, wherein static background is removed from the raw image or Imorph.

17. The method of embodiment 15 or embodiment 16, wherein morphological opening operations “B” comprise an erosion filter and a dilation filter.

18. The method of embodiment 17, wherein the erosion filter and dilation filter of morphological opening operation “B” utilize a disk-shaped structuring element with a diameter of ≥1.1D.

19. The method of any one of embodiments 1 to 18, which further comprises analyzing the quality of individual spots in the microarray, e.g., to characterize the quality of a positionally addressable microarray.

20. The method of any one of embodiments 1 to 19, which further comprises determining the non-static background of individual spots.

21. The method of embodiment 19, wherein calculating the non-static background of an individual spot comprises:
(a) sorting pixels in the background region of an individual spot window, optionally in a flat image of the spot, according to their value;
(b) calculating the median intensity of the pixels in the lower half (MED_{L});
(c) calculating the median absolute deviation (MAD_{L}) of the pixels in the lower half; and
(d) determining the non-static background based on MED_{L} and MAD_{L}.

22. The method of embodiment 21, wherein the determining the non-static background comprises applying the formula mean (background)=MED_{L}+1.4×MAD_{L}

23. The method of any one of embodiments 1 to 22, wherein analyzing the quality of an individual spot comprises:
(a) determining if a dust particle is present on the individual spot; and/or
(b) determining the degree of asymmetry of the individual spot.

24. The method of embodiment 23, wherein determining if a dust particle is present on the individual spot comprises analyzing the concavity of a spot intensity profile of the individual spot.

25. The method of embodiment 24, wherein analyzing the concavity of the spot intensity profile comprises:
(a) mapping the diameter of a spot intensity region with intensity thresholds ranging from 0 to the maximum pixel intensity, thereby generating a spot intensity profile; and
(b) determining if the spot intensity profile has a concave region, wherein a concave region in the spot intensity profile of the spot is indicative of a dust particle.

26. The method of any one of embodiments 23 to 25, wherein determining the degree of asymmetry of the individual spot comprises:
(a) sectioning the spot into a plurality of rings;
(b) determining the maximum and average pixel intensity values in each ring; and
(c) calculating an asymmetry score for each ring based on the difference between maximum and average pixel intensity values in the ring.

27. The method of any one of embodiments 1 to 26, wherein the spot array comprises at least 12 spots.

28. The method of embodiment 27, wherein the spot array comprises at least 24 spots.

29. The method of embodiment 27, wherein the spot array comprises at least 48 spots.

30. The method of embodiment 27, wherein the spot array comprises at least 72 spots.

31. The method of any one of embodiment 1 to 30, wherein the spots are three-dimensional.

32. The method of embodiment 31, which further comprises, prior to step (a), printing a plurality of fluorescently labeled probe molecules in three-dimensional spots at discrete locations on a solid surface to form the spot array.

33. The method of embodiment 32, wherein the printing comprises operating a movable printer head to deposit the plurality of fluorescently labeled probe molecules in spots at discrete locations on the solid surface.

34. The method of any one of embodiments 1 to 33, wherein the fluorescently labeled probe molecules are labeled with Cy3 and/or Cy5.

35. The method of any one of embodiments 1 to 34, wherein the spots are printed on the array in a grid pattern.

36. The method of any one of embodiments 1 to 35, wherein the array has a spot density of at least 20 spots/cm², at least 50 spots/cm², or at least 100 spots/cm².

37. The method of any one of embodiments 1 to 36, wherein each spot in the array corresponds to a diameter of at least 18 pixels on the raw image.

38. The method of any one of embodiments 1 to 36, wherein each spot in the array corresponds to a diameter of at least 20 pixels on the raw image.

39. The method of any one of embodiments 1 to 36, wherein each spot in the array corresponds to a diameter of at least 22 pixels on the raw image.

40. The method of any one of embodiments 1 to 39, wherein the spots are composed of a three-dimensional crosslinked polymer network attached to the labeled probe molecules.

41. The method of any one of embodiments 1 to 40, wherein the spot array is in a well of a 96-well plate.

42. The method of embodiment 41, which further comprises repeating the method for each array in the 96-well plate.

43. The method of any one of embodiments 1 to 42, wherein the spot array is on a slide.

44. The method of any one of embodiments 1 to 42, wherein the spot array is on a biochip.

45. The method of any one of embodiments 1 to 42, wherein the spot array is on a cartridge.

46. The method of any one of embodiments 1 to 45, wherein the reference array is generated in the absence of thresholding.

47. The method of any one of embodiments 1 to 46, which does not utilize predetermined and/or user defined array parameters.

48. The method of any one of embodiments 1 to 47, which further comprises assigning each spot a pass/fail score.

49. The method of any one of embodiments 1 to 48, which further comprises assigning the array a pass/fail score.

50. The method of any one of embodiments 1 to 49, which further comprises using an array characterized as having adequate quality in a hybridization assay.

51. The method of any one of embodiments 1 to 49, which further comprises discarding an array characterized as having inadequate quality.

52. A computer-implemented method for identifying the positional address of spots on a microarray, comprising, in a computer system having one or more processors coupled to a memory storing one or more computer readable instructions for execution by the one or more processors, the one or more computer readable instructions comprising instructions for:
(a) receiving raw images obtained by:
   (i) illuminating a microarray (the “array”) comprising labeled probe molecules present in spots on the array (the “spot array”) such that the label in the probe molecules is excited, optionally wherein the labeled probe molecules are fluorescently labeled probe molecules; and
   (ii) detecting the signals emitted by the labeled molecules;
(b) processing the detected signals into a raw image;
(c) locating the spot array on the raw image using a reference array; and
(d) optionally, analyzing the quality of individual spots in the microarray,
thereby identifying the positional address of spots on a microarray and optionally analyzing the quality of individual spots in the microarray, e.g., to characterize the quality of a positionally addressable microarray.

53. The computer-implemented method of embodiment 52, wherein the reference array is generated using raw image data.

54. The computer-implemented method of embodiment 52 or embodiment 53, wherein locating the spot array comprises:
(a) detecting raw image parameters; and
(b) locating the spot array based on the raw image parameters.

55. The computer-implemented method of any one of embodiments 52 to 54, wherein locating the spot array comprises performing an autocorrelation function on the raw image to produce an autocorrelation image.

56. The computer-implemented method of embodiment 55, wherein performing the autocorrelation function comprises performing a normalized autocorrelation.

57. The computer-implemented method of embodiment 55 or embodiment 56, wherein detecting the spot array further comprises, using autocorrelation data:
(a) calculating the diameter (“D”) of the central spot on the autocorrelation image;
(b) calculating the pitch between adjacent peaks (e.g., the central peak and adjacent peaks) on the autocorrelation image;
(c) constructing a reference array using the diameter and pitch values;
(d) calculating a morphological presentation of the raw image (Imorph); and
(e) correlating the reference array with the Imorph to locate the spot array on the raw image.

58. The computer-implemented method of embodiment 57, wherein the diameter of the central spot on the autocorrelation image is calculated using a Gaussian fitting algorithm which is optionally a 2D Gaussian fitting algorithm.

59. The computer-implemented method of embodiment 57 or embodiment 58, wherein the pitch is calculated as the mean distance between peaks in the autocorrelation image.

60. The computer-implemented method of embodiment 59, wherein the adjacent peaks comprise adjacent peaks along the horizontal central line.

61. The computer-implemented method of embodiment 59 or embodiment 60, wherein the adjacent peaks comprise adjacent peaks along the vertical central line.

62. The computer-implemented method of any one of embodiments 57 to 61, wherein generating a morphological presentation of the raw image (Imorph) comprises applying morphological opening operations (“A”) to the raw image.

63. The computer-implemented method of embodiment 62, wherein morphological opening operations “A” comprise an erosion filter and a dilation filter.

64. The computer-implemented method of embodiment 63, wherein the erosion filter and dilation filter of morphological opening operation “A” utilize a disk-shaped structuring element with a diameter of ≤0.9D.

65. The computer-implemented method of any one of embodiments 52 to 64, which comprises applying morphological opening operations “B” to calculate and remove static background, thereby generating a flat image.

66. The computer-implemented method of embodiment 65, wherein static background is removed from the raw image or Imorph.

67. The method of embodiment 65 or embodiment 66, wherein morphological opening operations “B” comprise an erosion filter and a dilation filter.

68. The method of embodiment 67, wherein the erosion filter and dilation filter of morphological opening operation “B” utilize a disk-shaped structuring element with a diameter of ≥1.1D.

69. The computer-implemented method of any one of embodiments 52 to 68, which further comprises analyzing the quality of individual spots in the microarray.

70. The computer-implemented method of any one of embodiments 52 to 69, which further comprises determining the non-static background of individual spots.

71. The computer-implemented method of embodiment 70 wherein calculating the non-static background of an individual spot comprises:
(a) sorting pixels in the background region of an individual spot window, optionally in a flat image of the spot, according to their value;
(b) calculating the median intensity of the pixels in the lower half (MED_{L});
(c) calculating the median absolute deviation (MAD_{L}) of the pixels in the lower half; and
(d) determining the non-static background based on MED_{L} and MAD_{L}.

72. The computer-implemented method of embodiment 71, the computer-implemented method of embodiment 72, wherein the determining the non-static background comprises applying the formula mean (background)=MEDL+1.4×MADL.

73. The computer-implemented method of any one of embodiments 52 to 72, wherein analyzing the quality of an individual spot comprises:
(a) determining if a dust particle is present on the individual spot; and/or
(b) determining the degree of asymmetry of the individual spot.

74. The computer-implemented method of embodiment 73, wherein determining if a dust particle is present on the individual spot comprises analyzing the concavity of a spot intensity profile of the individual spot.

75. The computer-implemented method of embodiment 74, wherein analyzing the concavity of the spot comprises:
(a) mapping the diameter of a spot intensity region with intensity thresholds ranging from 0 to the maximum pixel intensity, thereby generating a spot intensity profile; and
(b) determining if the spot intensity profile has a concave region, wherein a concave region in the spot intensity profile of the spot is indicative of a dust particle.

76. The computer-implemented method of any one of embodiments 73 to 75, wherein determining the degree of asymmetry of the individual spot comprises:
(a) sectioning the spot into a plurality of rings;
(b) determining the maximum and average pixel intensity values in each ring; and
(c) calculating an asymmetry score for each ring based on the difference between maximum and average pixel intensity values in the ring.

77. The computer-implemented method of any one of embodiments 52 to 76, wherein the spot array comprises at least 12 spots.

78. The computer-implemented method of embodiment 77, wherein the spot array comprises at least 24 spots.

79. The computer-implemented method of embodiment 77, wherein the spot array comprises at least 48 spots.

80. The computer-implemented method of embodiment 77, wherein the spot array comprises at least 72 spots.

81. The computer-implemented method of any one of embodiment 52 to 80 wherein the spots are three-dimensional.

82. The computer-implemented method of any one of embodiments 52 to 81, wherein the spots are printed on the array in a grid pattern.

83. The computer-implemented method of any one of embodiments 52 to 82, wherein the array has a spot density of at least 20 spots/cm², at least 50 spots/cm², or at least 100 spots/cm².

84. The computer-implemented method of any one of embodiments 52 to 83, wherein each spot in the array corresponds to a diameter of at least 18 pixels on the raw image.

85. The computer-implemented method of any one of embodiments 52 to 83, wherein each spot in the array corresponds to a diameter of at least 20 pixels on the raw image.

86. The computer-implemented method of any one of embodiments 52 to 83, wherein each spot in the array corresponds to a diameter of at least 22 pixels on the raw image.

87. The computer-implemented method of any one of embodiments 52 to 86, wherein the reference array is generated in the absence of thresholding.

88. The computer-implemented method of any one of embodiments 52 to 87, which does not comprise utilizing predetermined and/or user defined array parameters.

89. The computer-implemented method of any one of embodiments 52 to 88, which further comprises assigning each spot a pass/fail score.

90. The computer-implemented method of any one of embodiments 52 to 89, which further comprises assigning the array a pass/fail score.

91. The computer-implemented method of any one of embodiments 52 to 90, further comprising providing a notification to a user, wherein the notification optionally concerns the positional address of spots on a microarray and/or the quality the of the microarray.

92. The computer implemented method of embodiment 91, wherein the notification comprises a pass/fail assessment.

93. The computer-implemented method of embodiment 91 or embodiment 92, wherein the notification comprises an array spot map.

94. A system configured to identifying the positional address of spots on a microarray and/or optionally analyzing the quality of individual spots in the microarray, e.g., to characterize the quality of a positionally addressable microarray by the computer-implemented methods of any one of embodiments 52 to 93.

95. The system of embodiment 94, which comprises one or more processors coupled to a memory storing one or more computer readable instructions for execution by the one or more processors.

96. The system of embodiment 94 or embodiment 95 which comprises a microscope.

97. The system of embodiment 96 wherein the microscope is attached to a platform capable of holding the microarray.

98. The system of any one of embodiments 94 to 97 which comprises a camera capable of capturing a fluorescent label.

99. The system of any one of embodiments 94 to 98 which comprises a light source.

100. The system of embodiment 99, wherein the light source is capable of exciting fluorescently labeled molecules on the array.

101. The system of embodiment 99 or embodiment 100, wherein the light source is capable of illuminating an array to permit its image to be captured.

102. The system of any one of embodiments 94 to 101, which comprises an array printing device.

103. The system of any one of embodiments 94 to 102, which comprises a robotic device capable of operating a plurality of its components.

### 7. CITATION OF REFERENCES

While various specific embodiments have been illustrated and described, it will be appreciated that various changes can be made without departing from the spirit and scope of the disclosure(s).

All publications, patents, patent applications and other documents cited in this application are hereby incorporated by reference in their entireties for all purposes to the same extent as if each individual publication, patent, patent application or other document were individually indicated to be incorporated by reference for all purposes. In the event that there is an inconsistency between the teachings of one or more of the references incorporated herein and the present disclosure, the teachings of the present specification are intended.

What is claimed is:

1. A method for characterizing identifying the positional address of spots on a microarray, comprising:
(a) illuminating a microarray (the “array”) comprising labeled probe molecules present in spots on the array (the “spot array”) such that the label in the probe molecules is excited, optionally wherein the probe molecules are fluorescently labeled;
(b) detecting the signals emitted by the labeled molecules;
(c) processing the detected signals into a raw image;
(d) locating the spot array on the raw image using a reference array; and
(e) optionally, analyzing the quality of individual spots in the microarray,
thereby identifying the positional address of spots on a microarray and optionally analyzing the quality of individual spots in the microarray, e.g., to characterize the quality of a positionally addressable microarray.

2. The method of claim 1, wherein the probe molecules are fluorescently labeled and wherein the signals detected are fluorescent signals.

3. The method of claim 1 or claim 2, wherein the reference array is generated using raw image data.

4. The method of any one of claims 1 to 3, wherein locating the spot array comprises:
(a) detecting raw image parameters; and
(b) locating the spot array based on the raw image parameters.

5. The method of any one of claims 1 to 4, wherein locating the spot array comprises performing an autocorrelation function on the raw image to produce an autocorrelation image.

6. The method of claim 5, wherein performing the autocorrelation function comprises performing a normalized autocorrelation.

7. The method of claim 5 or claim 6, wherein detecting the spot array further comprises, using autocorrelation data:
(a) calculating the diameter (“D”) of the central spot on the autocorrelation image;
(b) calculating the pitch between adjacent peaks (e.g., the central peak and adjacent peaks) on the autocorrelation image;
(c) constructing a reference array using the diameter and pitch values;
(d) calculating a morphological presentation of the raw image (Imorph); and
(e) correlating the reference array with the Imorph to locate the spot array on the raw image.

8. The method of claim 7, wherein the diameter of the central spot on the autocorrelation image is calculated using a Gaussian fitting algorithm which is optionally a 2D Gaussian fitting algorithm.

9. The method of claim 7 or claim 8, wherein the pitch is calculated as the mean distance between peaks in the autocorrelation image.

10. The method of claim 9, wherein the adjacent peaks comprise adjacent peaks along the horizontal central line.

11. The method of claim 9 or claim 10, wherein the adjacent peaks comprise adjacent peaks along the vertical central line.

12. The method of any one of claims 7 to 11, wherein generating a morphological presentation of the raw image (Imorph) comprises applying morphological opening operations “A”) to the raw image.

13. The method of claim 12, wherein morphological opening operations “A” comprise an erosion filter and a dilation filter.

14. The method of claim 13, wherein the erosion filter and dilation filter of morphological opening operation “A” utilize a disk-shaped structuring element with a diameter of ≤0.9D.

15. The method of any one of claims 1 to 14, which comprises applying morphological opening operations “B” to calculate and remove static background, thereby generating a flat image.

16. The method of claim 15, wherein static background is removed from the raw image or Imorph.

17. The method of claim 15 or claim 16, wherein morphological opening operations “B” comprise an erosion filter and a dilation filter.

18. The method of claim 17, wherein the erosion filter and dilation filter of morphological opening operation “B” utilize a disk-shaped structuring element with a diameter of ≥1.1D.

19. The method of any one of claims 1 to 18, which further comprises analyzing the quality of individual spots in the microarray, e.g., to characterize the quality of a positionally addressable microarray.

20. The method of any one of claims 1 to 19, which further comprises determining the non-static background of individual spots.

21. The method of claim 19, wherein calculating the non-static background of an individual spot comprises:
(a) sorting pixels in the background region of an individual spot window, optionally in a flat image of the spot, according to their value;
(b) calculating the median intensity of the pixels in the lower half (MED_{L});
(c) calculating the median absolute deviation (MAD_{L}) of the pixels in the lower half; and
(d) determining the non-static background based on MED_{L} and MAD_{L}.

22. The method of claim 21, wherein the determining the non-static background comprises applying the formula mean (background)=MED_{L}+1.4×MAD_{L}

23. The method of any one of claims 1 to 22, wherein analyzing the quality of an individual spot comprises:
(a) determining if a dust particle is present on the individual spot; and/or
(b) determining the degree of asymmetry of the individual spot.

24. The method of claim 23, wherein determining if a dust particle is present on the individual spot comprises analyzing the concavity of a spot intensity profile of the individual spot.

25. The method of claim 24, wherein analyzing the concavity of the spot intensity profile comprises:
(a) mapping the diameter of a spot intensity region with intensity thresholds ranging from 0 to the maximum pixel intensity, thereby generating a spot intensity profile; and
(b) determining if the spot intensity profile has a concave region, wherein a concave region in the spot intensity profile of the spot is indicative of a dust particle.

26. The method of any one of claims 23 to 25, wherein determining the degree of asymmetry of the individual spot comprises:
(a) sectioning the spot into a plurality of rings;
(b) determining the maximum and average pixel intensity values in each ring; and
(c) calculating an asymmetry score for each ring based on the difference between maximum and average pixel intensity values in the ring.

27. The method of any one of claims 1 to 26, wherein the spot array comprises at least 12 spots.

28. The method of claim 27, wherein the spot array comprises at least 24 spots.

29. The method of claim 27, wherein the spot array comprises at least 48 spots.

30. The method of claim 27, wherein the spot array comprises at least 72 spots.

31. The method of any one of claims 1 to 30, wherein the spots are three-dimensional.

32. The method of claim 31, which further comprises, prior to step (a), printing a plurality of fluorescently labeled probe molecules in three-dimensional spots at discrete locations on a solid surface to form the spot array.

33. The method of claim 32, wherein the printing comprises operating a movable printer head to deposit the plurality of fluorescently labeled probe molecules in spots at discrete locations on the solid surface.

34. The method of any one of claims 1 to 33, wherein the fluorescently labeled probe molecules are labeled with Cy3 and/or Cy5.

35. The method of any one of claims 1 to 34, wherein the spots are printed on the array in a grid pattern.

36. The method of any one of claims 1 to 35, wherein the array has a spot density of at least 20 spots/cm², at least 50 spots/cm², or at least 100 spots/cm².

37. The method of any one of claims 1 to 36, wherein each spot in the array corresponds to a diameter of at least 18 pixels on the raw image.

38. The method of any one of claims 1 to 36, wherein each spot in the array corresponds to a diameter of at least 20 pixels on the raw image.

39. The method of any one of claims 1 to 36, wherein each spot in the array corresponds to a diameter of at least 22 pixels on the raw image.

40. The method of any one of claims 1 to 39, wherein the spots are composed of a three-dimensional crosslinked polymer network attached to the labeled probe molecules.

41. The method of any one of claims 1 to 40, wherein the spot array is in a well of a 96-well plate.

42. The method of claim 41, which further comprises repeating the method for each array in the 96-well plate.

43. The method of any one of claims 1 to 42, wherein the spot array is on a slide.

44. The method of any one of claims 1 to 42, wherein the spot array is on a biochip.

45. The method of any one of claims 1 to 42, wherein the spot array is on a cartridge.

46. The method of any one of claims 1 to 45, wherein the reference array is generated in the absence of thresholding.

47. The method of any one of claims 1 to 46, which does not utilize predetermined and/or user defined array parameters.

48. The method of any one of claims 1 to 47, which further comprises assigning each spot a pass/fail score.

49. The method of any one of claims 1 to 48, which further comprises assigning the array a pass/fail score.

50. The method of any one of claims 1 to 49, which further comprises using an array characterized as having adequate quality in a hybridization assay.

51. The method of any one of claims 1 to 49, which further comprises discarding an array characterized as having inadequate quality.

52. A computer-implemented method for identifying the positional address of spots on a microarray, comprising, in a computer system having one or more processors coupled to a memory storing one or more computer readable instructions for execution by the one or more processors, the one or more computer readable instructions comprising instructions for:
(a) receiving raw images obtained by:
(i) illuminating a microarray (the “array”) comprising labeled probe molecules present in spots on the array (the “spot array”) such that the label in the probe molecules is excited, optionally wherein the labeled probe molecules are fluorescently labeled probe molecules; and
(ii) detecting the signals emitted by the labeled molecules;
(b) processing the detected signals into a raw image;
(c) locating the spot array on the raw image using a reference array; and
(d) optionally, analyzing the quality of individual spots in the microarray,
thereby identifying the positional address of spots on a microarray and optionally analyzing the quality of individual spots in the microarray, e.g., to characterize the quality of a positionally addressable microarray.

53. The computer-implemented method of claim 52, wherein the reference array is generated using raw image data.

54. The computer-implemented method of claim 52 or claim 53, wherein locating the spot array comprises:
(a) detecting raw image parameters; and
(b) locating the spot array based on the raw image parameters.

55. The computer-implemented method of any one of claims 52 to 54, wherein locating the spot array comprises performing an autocorrelation function on the raw image to produce an autocorrelation image.

56. The computer-implemented method of claim 55, wherein performing the autocorrelation function comprises performing a normalized autocorrelation.

57. The computer-implemented method of claim 55 or claim 56, wherein detecting the spot array further comprises, using autocorrelation data:
(a) calculating the diameter (“D”) of the central spot on the autocorrelation image;
(b) calculating the pitch between adjacent peaks (e.g., the central peak and adjacent peaks) on the autocorrelation image;
(c) constructing a reference array using the diameter and pitch values;
(d) calculating a morphological presentation of the raw image (Imorph); and
(e) correlating the reference array with the Imorph to locate the spot array on the raw image.

58. The computer-implemented method of claim 57, wherein the diameter of the central spot on the autocorrelation image is calculated using a Gaussian fitting algorithm which is optionally a 2D Gaussian fitting algorithm.

59. The computer-implemented method of claim 57 or claim 58, wherein the pitch is calculated as the mean distance between peaks in the autocorrelation image.

60. The computer-implemented method of claim 59, wherein the adjacent peaks comprise adjacent peaks along the horizontal central line.

61. The computer-implemented method of claim 59 or claim 60, wherein the adjacent peaks comprise adjacent peaks along the vertical central line.

62. The computer-implemented method of any one of claims 57 to 61, wherein generating a morphological presentation of the raw image (Imorph) comprises applying morphological opening operations (“A”) to the raw image.

63. The computer-implemented method of claim 62, wherein morphological opening operations “A” comprise an erosion filter and a dilation filter.

64. The computer-implemented method of claim 63, wherein the erosion filter and dilation filter of morphological opening operation “A” utilize a disk-shaped structuring element with a diameter of ≤0.9D.

65. The computer-implemented method of any one of claims 52 to 64, which comprises applying morphological opening operations “B” to calculate and remove static background, thereby generating a flat image.

66. The computer-implemented method of claim 65, wherein static background is removed from the raw image or Imorph.

67. The method of claim 65 or claim 66, wherein morphological opening operations “B” comprise an erosion filter and a dilation filter.

68. The method of claim 67, wherein the erosion filter and dilation filter of morphological opening operation “B” utilize a disk-shaped structuring element with a diameter of ≥1.1D.

69. The computer-implemented method of any one of claims 52 to 68, which further comprises analyzing the quality of individual spots in the microarray.

70. The computer-implemented method of any one of claims 52 to 69, which further comprises determining the non-static background of individual spots.

71. The computer-implemented method of claim 70 wherein calculating the non-static background of an individual spot comprises:
(a) sorting pixels in the background region of an individual spot window, optionally in a flat image of the spot, according to their value;
(b) calculating the median intensity of the pixels in the lower half (MED_{L});
(c) calculating the median absolute deviation (MAD_{L}) of the pixels in the lower half; and
(d) determining the non-static background based on MED_{L} and MAD_{L}.

72. The computer-implemented method of claim 71, the computer-implemented method of claim 72, wherein the determining the non-static background comprises applying the formula mean (background)=MEDL+1.4×MADL.

73. The computer-implemented method of any one of claims 52 to 72, wherein analyzing the quality of an individual spot comprises:
(a) determining if a dust particle is present on the individual spot; and/or
(b) determining the degree of asymmetry of the individual spot.

74. The computer-implemented method of claim 73, wherein determining if a dust particle is present on the individual spot comprises analyzing the concavity of a spot intensity profile of the individual spot.

75. The computer-implemented method of claim 74, wherein analyzing the concavity of the spot comprises:
(a) mapping the diameter of a spot intensity region with intensity thresholds ranging from 0 to the maximum pixel intensity, thereby generating a spot intensity profile; and
(b) determining if the spot intensity profile has a concave region, wherein a concave region in the spot intensity profile of the spot is indicative of a dust particle.

76. The computer-implemented method of any one of claims 73 to 75, wherein determining the degree of asymmetry of the individual spot comprises:
(a) sectioning the spot into a plurality of rings;
(b) determining the maximum and average pixel intensity values in each ring; and
(c) calculating an asymmetry score for each ring based on the difference between maximum and average pixel intensity values in the ring.

77. The computer-implemented method of any one of claims 52 to 76, wherein the spot array comprises at least 12 spots.

78. The computer-implemented method of claim 77, wherein the spot array comprises at least 24 spots.

79. The computer-implemented method of claim 77, wherein the spot array comprises at least 48 spots.

80. The computer-implemented method of claim 77, wherein the spot array comprises at least 72 spots.

81. The computer-implemented method of any one of claims 52 to 80 wherein the spots are three-dimensional.

82. The computer-implemented method of any one of claims 52 to 81, wherein the spots are printed on the array in a grid pattern.

83. The computer-implemented method of any one of claims 52 to 82, wherein the array has a spot density of at least 20 spots/cm², at least 50 spots/cm², or at least 100 spots/cm².

84. The computer-implemented method of any one of claims 52 to 83, wherein each spot in the array corresponds to a diameter of at least 18 pixels on the raw image.

85. The computer-implemented method of any one of claims 52 to 83, wherein each spot in the array corresponds to a diameter of at least 20 pixels on the raw image.

86. The computer-implemented method of any one of claims 52 to 83, wherein each spot in the array corresponds to a diameter of at least 22 pixels on the raw image.

87. The computer-implemented method of any one of claims 52 to 86, wherein the reference array is generated in the absence of thresholding.

88. The computer-implemented method of any one of claims 52 to 87, which does not comprise utilizing predetermined and/or user defined array parameters.

89. The computer-implemented method of any one of claims 52 to 88, which further comprises assigning each spot a pass/fail score.

90. The computer-implemented method of any one of claims 52 to 89, which further comprises assigning the array a pass/fail score.

91. The computer-implemented method of any one of claims 52 to 90, further comprising providing a notification to a user, wherein the notification optionally concerns the positional address of spots on a microarray and/or the quality the of the microarray.

92. The computer implemented method of claim 91, wherein the notification comprises a pass/fail assessment.

93. The computer-implemented method of claim 91 or claim 92, wherein the notification comprises an array spot map.

94. A system configured to identifying the positional address of spots on a microarray and/or optionally analyzing the quality of individual spots in the microarray, e.g., to characterize the quality of a positionally addressable microarray by the computer-implemented methods of any one of claims 52 to 93.

95. The system of claim 94, which comprises one or more processors coupled to a memory storing one or more computer readable instructions for execution by the one or more processors.

96. The system of claim 94 or claim 95 which comprises a microscope.

97. The system of claim 96 wherein the microscope is attached to a platform capable of holding the microarray.

98. The system of any one of claims 94 to 97 which comprises a camera capable of capturing a fluorescent label.

99. The system of any one of claims 94 to 98 which comprises a light source.

100. The system of claim 99, wherein the light source is capable of exciting fluorescently labeled molecules on the array.

101. The system of claim 99 or claim 100, wherein the light source is capable of illuminating an array to permit its image to be captured.

102. The system of any one of claims 94 to 101, which comprises an array printing device.

103. The system of any one of claims 94 to 102, which comprises a robotic device capable of operating a plurality of its components.
